(19) United States
(12) Patent Application Publication
(10) Pub. No.: US 2010/0141051 A1
(43) Pub. Date: Jun. 10, 2010

(54) DEVICE FOR CONVERTING AN ELECTROMAGNETIC WAVE INTO DC VOLTAGE

(76) Inventor: Christian Vollaire, Tassin (FR)

Correspondence Address: ARENT FOX LLP, 1050 CONNECTICUT AVENUE, N.W., SUITE 400, WASHINGTON, DC, 20036, US

(21) Appl. No.: 12/300,600

(22) PCT Filed: May 11, 2007
(86) PCT No.: PCT/FR07/51250

§ 371 Date: Dec. 19, 2008

(30) Foreign Application Priority Data
May 12, 2006 (FR) 0604264

(51) Int. Cl. H02J 17/00

(52) U.S. Cl. 307/151

(57) ABSTRACT

The invention relates to a device (1) for converting an electromagnetic wave (11) into a DC voltage, comprising: —at least one antenna (3) suitable for converting said electromagnetic wave (11) into an input electrical signal;—a first filter (4) suitable for filtering said input electrical signal and generating a filtered signal;—a full-wave rectifier (5) suitable for rectifying said filtered signal and generating an output voltage;—a second filter (6) suitable for filtering said output voltage so as to generate said DC voltage, in which the first filter (4) and the second filter (6) are arranged so as to comply with a concatenation of current and voltage sources through the rectifier (5).

The present invention relates to the field of devices for converting an electromagnetic wave, and in particular microwaves, into a DC voltage.

It concerns more particularly a device for converting an electromagnetic wave into a DC voltage comprising:
at least one antenna able to convert the said electromagnetic wave into an input electrical signal;
a first filter able to filter the said input electrical signal and generate a filtered signal;
a rectifier able to rectify the said filtered signal and generate an output voltage;
a second filter able to filter the said output voltage so as to generate the said DC voltage.

Such a device is for example known from the French patent document 2 646 739. In the aforementioned patent, the rectifier consists of a single diode and constitutes a half-wave rectifier.

Such a device can be used for supplying appliances remotely. In this case, microwaves generated by a microwave source are received by the conversion device, which converts the wave received into a DC voltage. This DC voltage can be used to supply a load, for example a rechargeable appliance.

Thus, when microwaves arrive at the antenna, an alternating voltage having a positive part and a negative part is generated. With such a half-wave rectifier, part of the energy picked up by the antenna is lost, which impairs the efficiency of the conversion device.

Such a device is also known from the American patent document U.S. Pat. No. 5,671,133. In the aforementioned patent, the converter consists of two diodes and constitutes a voltage doubler. This type of converter functions correctly off load but proves ineffective for operations on load. In addition its functioning requires the charging of capacitors, which prevents compliance with the linking of resources required for optimal power transfer.

The document U.S. Pat. No. 6,427,065 is also known, which describes a device for converting an electromagnetic wave into a DC voltage, comprising:
at least one antenna able to convert the said electromagnetic wave into an input electrical signal;
a first filter able to filter the said input electrical signal and generate a filtered signal;
a rectifier able to rectify the said filtered signal and generate an output voltage;
a second filter (6) able to filter the said output voltage so as to generate the said DC voltage,
   in which the rectifier is a full-wave rectifier.

Using a full-wave rectifier improves the efficiency of the convertor.

However, it is advantageous to improve this efficiency further.

A first aim of the invention is therefore to improve the efficiency in a device for converting an electromagnetic wave into a DC voltage.

Another aim of the invention is to limit the energy level of the electromagnetic wave to be supplied to a convertor for converting an electromagnetic wave into a DC voltage, while maintaining a satisfactory electrical energy.

At least one of these aims is achieved by the present invention, which concerns, according to a first aspect, a device for converting an electromagnetic wave into a DC voltage comprising:
at least one antenna able to convert the said electromagnetic wave into an input electrical signal;
a first filter able to filter the said input electrical signal and generate a filtered signal;
a full-wave rectifier able to rectify the said filtered signal and generate an output voltage;
a second filter able to filter the said output voltage so as to generate the said DC voltage,
   in which the first filter and the second filter are arranged so as to comply with a concatenation of the current and voltage sources through the rectifier.

By virtue of the arrangement of the first filter and second filter complying with the concatenation of the current and voltage sources through the rectifier, the efficiency of the converter is improved.

This principle is known in the field of low-frequency power electronics but has never been used in the context of a converter for converting an electromagnetic wave into a DC voltage. However, it has been demonstrated, in the context of the invention, that such an arrangement complying with the principle of static conversion of electrical energy within the meaning of power electronics considerably limits the losses in the conversion efficiency.

According to a first embodiment, the rectifier is a direct rectifier, the first filter is a voltage generator seen from the rectifier and the second filter is a current generator seen from the rectifier.

According to a second embodiment, the rectifier is a direct rectifier, the first filter is a current generator seen from the rectifier and the second filter is a voltage generator seen from the rectifier.

In these two embodiments, since the rectifier is direct, a concatenation of sources of different natures, voltage to current or current to voltage, is indeed complied with, which improves the efficiency of conversion.

According to one embodiment of the invention, the electromagnetic wave is a wave in the microwave range, and the antenna is arranged to convert the microwave. In this frequency range, full-wave rectification is not used in the devices for conversion into a DC voltage known from the prior art.

This full-wave rectifier is for example a Graetz bridge solely composed of diodes.

Thus, by using a full-wave rectifier such as a Graetz bridge as a rectifier in a device for converting an electromagnetic wave into a DC voltage, the whole of the energy received by the antenna is rectified and converted into DC energy. This therefore improves the efficiency of the convertor.

It is known how to use diodes in particular in the field of microwaves to achieve rectification. However, in this case, only the quadratic characteristic of the diodes is used, making it possible for example to transform a sine function into a square sine function. This method comes from demodulation techniques. However, in this part of its characteristic, the diode dissipates a great deal of power, which impairs the efficiency of the device.

On the other hand, a full-wave rectifier such as a Graetz bridge according to the invention makes it possible to maintain good efficiency for the conversion device since the diodes within the Graetz bridge function in switching mode, that is to say in a part of their characteristic where the losses are low.

Such a Graetz bridge has never been used in devices for converting microwaves into a DC voltage in particular because the use of diodes in switching mode is not widespread in the microwave community since the diodes are used for purposes of demodulation, which leads to using another part of their characteristic.

Conversion structures such as Graetz bridges are normally at low frequency but without any care for impedance matching, which amounts to rejecting harmonics on the supply network, which is of infinite power with respect to the load.

According to a second aspect, the invention relates to a device for converting microwaves into a DC voltage. Such a microwave conversion device is more particularly referred to as a rectenna. The aforementioned application FR 2 646 739 concerns more particularly this technical field of rectennae.

According to this second aspect, the invention relates to a device for converting microwaves into a DC voltage comprising:
at least one antenna able to convert the microwaves into an input electrical signal;
a first filter able to filter the said input electrical signal and generate a filtered signal;
a rectifier able to rectify the said filter signal and generate an output voltage;
a second filter able to filter the said output voltage so as to generate the said DC voltage,
   in which the rectifier is a full-wave rectifier, in particular a bridge comprising solely diodes in switching mode, for example a Graetz bridge.

Such a device in effect makes it possible already, in the field of microwaves, to improve the efficiency of known microwave converters. Consequently the above device resolves the problem of improving the efficiency of the microwave converter, independently of the arrangement of the filters described above complying with concatenation of the current and voltage sources through the rectifier.

For a microwave conversion device, improving the efficiency is particularly important with regard to the standards preventing the emission of microwaves beyond a certain energy.

The concatenation of the sources described previously then makes it possible, for a microwave convertor of the rectenna type, to improve the conversion efficiency further.

Moreover, the filtering according to the invention between the antenna and the rectifier by the first filter cannot be envisaged at low frequencies because of the size of the components in this frequency range. This first filter makes it possible in particular to effect an impedance matching, which is a major preoccupation in microwave frequencies in order to be able to pick up a maximum amount of energy of the incident wave with the reception antenna.

Moreover, in order to improve the transfer of power between the antenna and the rectifier, the said first filter comprises a first input electrical component arranged to receive the said input signal, and in which the said first input electrical component is an inductor.

In this way, as the antenna is a voltage source, the first component encountered by the current output from the antenna is of the current generator type. This concatenation respecting the property of concatenation of sources, voltage generator and then current generator, therefore improves the power transfer.

Moreover, in order to improve the power transfer between the first filter and the second filter, the said rectifier is a direct rectifier and the said first filter comprises an output electrical component, the said output electrical component being a capacitor, and the said second filter comprises a second input electrical component arranged to receive the said output voltage, the said second input electrical component being an inductor.

In the same way, the said rectifier is a direct rectifier and the said first filter comprises an output electrical component, the said output electrical component being an inductor, and the said second filter comprises a second input electrical component arranged to receive the said output voltage, the said second input electrical component being a capacitor.

In this way, the rectifier being a direct rectifier, there is no energy accumulation element within the rectifier, and the concatenation of sources, voltage generator and then current generator, therefore improves the power transfer.

In addition, in order to obtain a maximum power transfer when the conversion device is used to supply a load, the invention also concerns an item of electrical equipment comprising a device as previously described, and a load able to be supplied by the said DC voltage, and the said first filter, the said rectifier, the said second filter and the said load form a returned assembly connected to the said antenna, the said returned assembly having a returned impedance, the said antenna having an antenna impedance, the said returned assembly being sized so that the said returned impedance is equal to the said antenna impedance.

Thus the filters, and in particular the impedances and capacitances of the filters, are chosen so as to effect an impedance matching in the device. As is known per se, the equality of the returned impedance and the impedance of the antenna makes it possible to maximise the energy transfer between the antenna and the load.

An embodiment of the invention is now described with reference to the accompanying figures, in which:

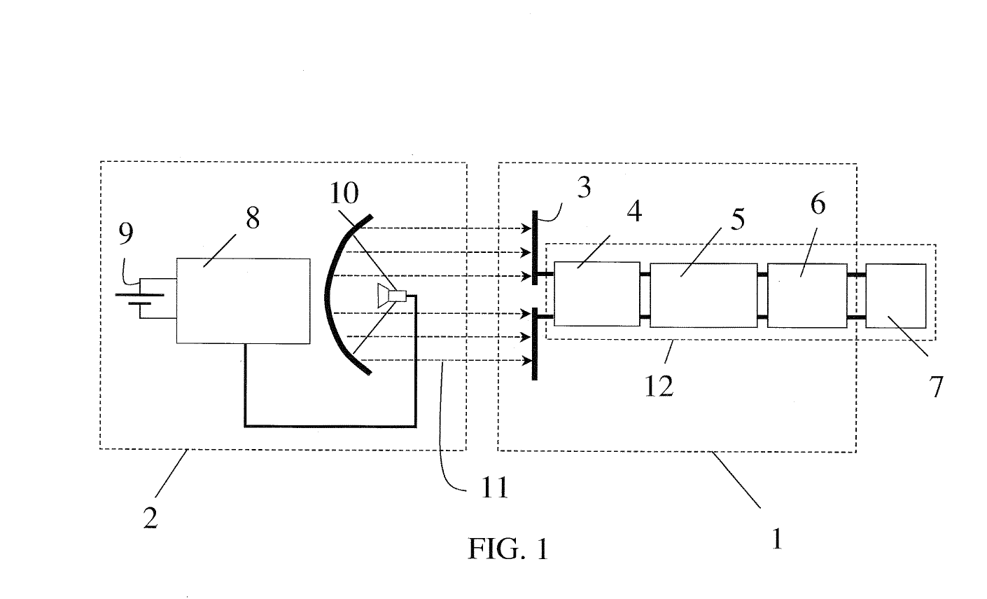

FIG. 1 is a general diagram of a device for converting an electromagnetic wave into a DC voltage according to the invention associated with a microwave electromagnetic source;

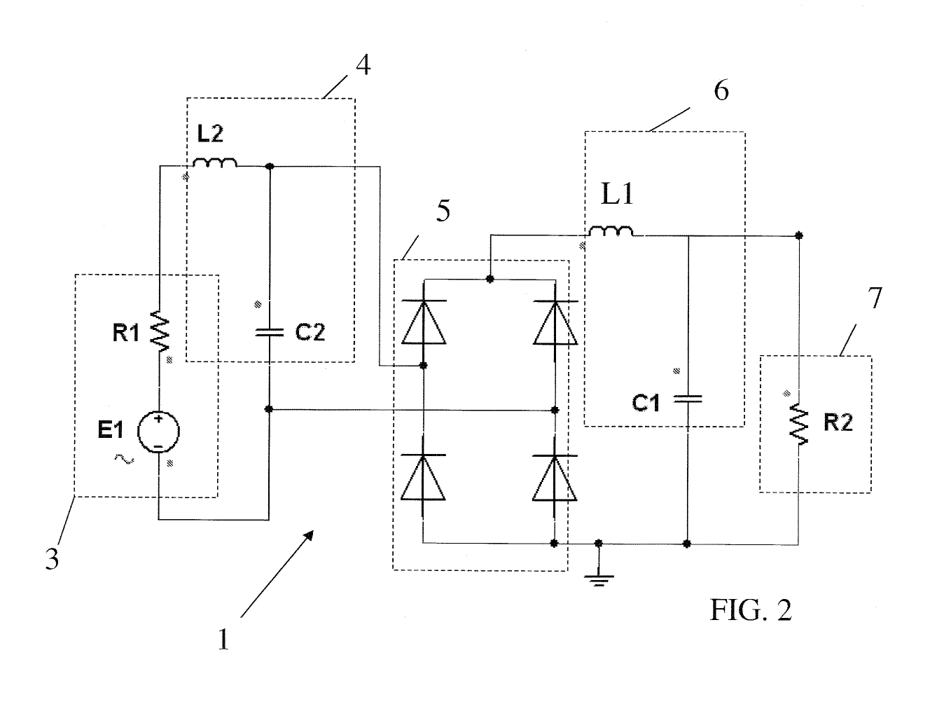

FIG. 2 is an electrical diagram of an example of an embodiment of a device for converting an electromagnetic wave into a DC voltage according to the invention;

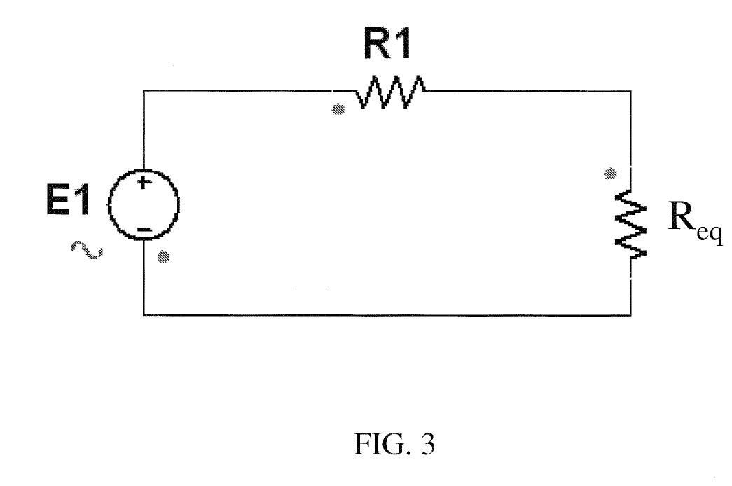

FIG. 3 is an electrical diagram of an electrical circuit equivalent to the circuit of FIG. 2 in terms of impedance;

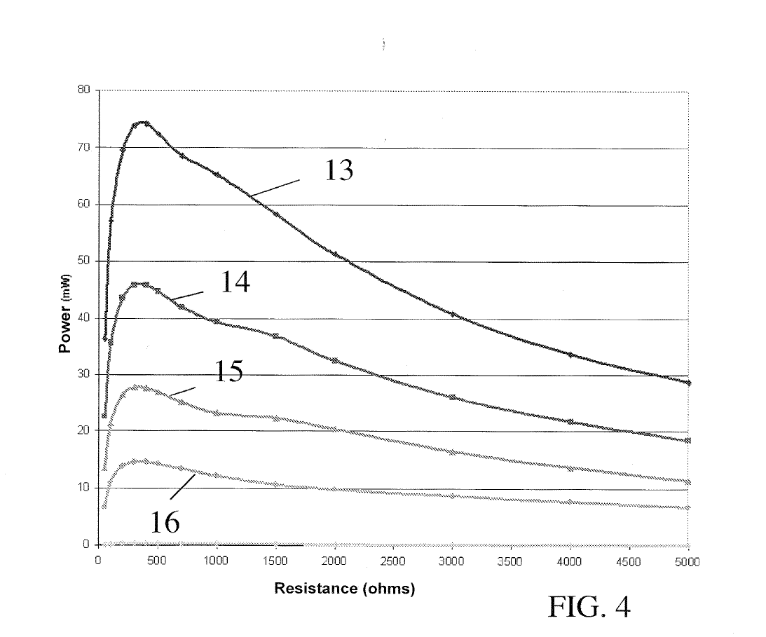

FIG. 4 is a graph depicting the power recovered at the terminals of a load in a device as illustrated in FIG. 1 as a function of the load resistance.

As illustrated in FIG. 1, a device 1 for converting an electromagnetic wave 11 into a DC voltage comprises an antenna 3. The antenna 3 is able to convert the electromagnetic wave 11 into an AC electrical signal. An association of several antennae 3 may possible be used in order to increase the reception surface. The AC electrical signal is then transmitted in the device 1 successively through a high-frequency filter 4, a full-wave rectifier 5 able to convert an AC signal into a rectified signal, and a DC filter 6. At the output of the DC filter 6, a DC voltage is generated. This DC voltage can then be applied to a load 7.

The electromagnetic wave 11 is for example a microwave signal 11 generated by an emitting device 2. This transmitting device 2 comprises for example a DC voltage generator 9, a microwave source 8 and a sending antenna 10. The microwaves generated by the emitter 2 have the advantage of being easily transmitted in an open environment in which the microwaves can propagate, which makes possible transmission at a distance to the receiving device. The emitting device is known to persons skilled in the art and will not be discussed in more detail hereinafter.

In the device 1 for receiving the electromagnetic wave 11, the function of the high-frequency filter 4 positioned between the antenna 3 and the rectifier 5 is to match the impedance seen by the antenna. This impedance matching will be discussed in more detail below.

Illustrated in FIG. 2, a particular embodiment of the various electrical components of the receiving device 1 of FIG. 1 is now described.

The antenna 3 can be modelled by a voltage generator E1 and a resistive impedance R1. The impedance R1 is for example equal to 50 ohms.

The high-frequency filter 4 comprises an inductor L2 connected directly to the impedance R1 of the antenna 3, and a capacitor C2 positioned in parallel to the antenna 3. The high-frequency filter 4 is a low-pass filter. The output of the high-frequency filter 4 is connected to a full-wave rectifier 5. This full-wave rectifier 5 is a Graetz bridge and comprises a set of four diodes, distributed over two arms of two diodes. The inputs of the bridge are situated at each of the two arms. The diodes of this full-wave rectifier 5 function in switching mode in a manner known per se.

The DC filter 6 is positioned at the output of the rectifier 5 and comprises an inductor L1 in series with the rectifier 5, and a capacitor C1 in parallel with the rectifier 5. The filter 6 is a low-pass filter.

The DC filter 6 makes it possible to generate a DC voltage able to be supplied to the load 7, which can be modelled by a resistor R2.

The value of the load 7 is calculated according to the consumption of the components to be supplied by the device 1. For example, for a component having a consumption of 10 mW at 5 volts, a resistance R2 of 2500 ohms will be taken.

The capacitors C1 and C2 and the inductors L1 and L2 are positioned so as to comply with the principle of the concatenation of sources so as to obtain a maximum power transfer.

This known principle of power electronics means that it is possible to connect only sources of different natures directly or through a direct converter, that is to say without an energy accumulator. If this condition is not complied with, it is known that the power transfer is not optimum.

Thus, according to the invention, the generator E1 and the resistor R1 modelling the antenna constitute a voltage generator. The inductor L2 being positioned at the head of the filter 4, the filter 4 is therefore seen as a current generator by the antenna 3. Next, the inductor L1 is positioned at the head of the filter 6, which is therefore seen as a current generator by the filter 4, which is itself a generator of an output voltage at C2. The rectifier 5 being a direct converter, the condition of concatenation of sources is indeed complied with according to the invention, which makes it possible to obtain a good power transfer.

According to other embodiments of the device, the order of the filters 4 and 6 can be increased, by positioning other inductors and capacitors. In these embodiments, these inductors and capacitors are also positioned so as to comply with the concatenation of voltage/current sources. In particular, if the output component of the filter 4 is an inductor, the input component of the filter 6 will be a capacitor so as to comply with this concatenation of sources.

In order to improve the transfer of energy between the antenna and the load, an impedance matching of the device 1 is implemented when it is connected to a load 7. The capacitors C1 and C2 and the inductors L1 and L2 are therefore sized so as to effect this impedance matching. Illustrated in FIG. 3, the components of the high-frequency filter 4, of the DC filter 6 and of the load 7 are sized so that the equivalent resistance of this assembly is equal to the resistance R1 of the antenna 3, that is to say R_{eq}=R1. Illustrated in FIG. 1, the high-frequency filter 4, the rectifier 5, the DC filter 6 and the load 7 form a returned assembly 12 having a returned impedance to be matched.

Because of the non-linearities introduced by the diode rectifier 5, the values of the components L1, C1, C2 and L2 cannot be calculated analytically and circuit calculation software is preferably used.

The applicant has determined values of the components L1, C1, L2 and C2 making it possible to achieve good impedance matching for an antenna with a purely resistive internal impedance of 50 ohms.

The values determined by the applicant are as follows:
L1=3.5 nH
C1=48 pF
L2=6.2 nH
C2=0.3 pF

These values were determined for functioning with an incident wave 11 at a frequency of 2.45 GHz and for a value of R2 for the load 7 of 500 ohms. The power obtained in the load 7 for an incident wave 11 of a 130 V/m module at the antenna is 73 mW.

FIG. 4 is a graph showing the power recovered at the terminals of the load 7 in the receiving device 1 as illustrated in FIG. 1 as a function of the resistance R2 of the load 7.

In FIG. 4, the curve 13 corresponds to an incident field 11 at the antenna 3 of 130 V/m. The curve 14 corresponds to an incident field 11 at the antenna 3 of 100 V/m. The curve 15 corresponds to an incident field 11 at the antenna 3 of 75 V/m. The cure 16 corresponds to an incident field 11 at the antenna 3 of 50 V/m.
L1=3.5 nH
C1=48 pF
L2=6.2 nH
C2=0.3 pF

These values were determined for functioning with an incident wave 11 at a frequency of 2.45 GHz.

The efficiencies obtained by the device 1 of the present invention make it possible to supply a DC voltage generator from in particular a microwave source, with good efficiency.

The invention can in particular be applied to remote supply and be inserted in an energy terminal for roaming apparatus or for recharging remotely. It can also be applied to the supply of microsystems.

1. A device for converting an electromagnetic wave into a DC voltage, comprising:
at least one antenna able to convert the said electromagnetic wave into an input electrical signal;
a first filter able to filter the said input electrical signal and generate a filtered signal;
a full-wave rectifier able to rectify the said filtered signal and generate an output voltage;
a second filter able to filter the said output voltage so as to generate the said DC voltage,
in which the first filter and the second filter are arranged so as to respect a concatenation of these sources in terms of current and voltage through the rectifier.

2. A device according to claim 1, in which the rectifier is a direct rectifier and in which the first filter is a voltage generator seen from the rectifier and the second filter is a current generator seen from the rectifier.

3. A device according to claim 1, in which the rectifier is a direct rectifier, and in which the first filter is a current generator seen from the rectifier and the second filter is a voltage generator seen from the rectifier.

4. A device according to claims 1, 2, or 3, in which the electromagnetic wave is a wave in the microwave range and in which the antenna is arranged to convert the microwave wave.

5. A device according to claims 1, 2, or 3, in which the rectifier is solely composed of switching diodes.

6. Electrical equipment comprising a device for converting an electromagnetic wave into a DC voltage according to any one of the preceding claims, and a load, the said load able to be supplied by the said DC voltage, and the said first filter, the said rectifier, the said second filter and the said load form a returned assembly connected to the said antenna, the said returned assembly having a returned impedance, the said antenna having an antenna impedance, the said returned assembly being sized so that the said returned impedance is equal to the said antenna impedance.
